(19) United States
(12) Patent Application Publication
(10) Pub. No.: US 2016/0364546 A1
(43) Pub. Date: Dec. 15, 2016

(54) SYSTEM FOR MERCHANDISING AT A SALES FACILITY

(71) Applicant: Menasha Corporation, Neenah, WI (US)

(72) Inventors: Paul D. Murphy, Delafield, WI (US); Will H. Phillips, Marietta, GA (US)

(21) Appl. No.: 15/178,785

(22) Filed: Jun. 10, 2016

Related U.S. Application Data
(60) Provisional application No. 62/174,726, filed on Jun. 12, 2015.

(51) Int. Cl. G06F 19/00; H04W 8/00; H04W 4/00; H04W 4/04

(52) U.S. Cl. CPC G06F 19/3456; H04W 4/04; H04W 8/005; H04W 4/008; G06F 19/326

(57) ABSTRACT

The present invention provides a system for merchandising at a sales facility. The system has a first wireless device of an owner, a second wireless device in the sales facility, a low-energy electronic beacon in the sales facility electronically having a transmission range not extending substantially beyond the sales facility, and a software application. When the software application is executed it causes the electronic beacon to transmit a polling beam in the sales facility, senses the presence of the first wireless device in the sales facility, determines the physical location of the first wireless device, searches the database for pertinent information of the owner; and displays on the display the identity of the owner, the physical location of the first wireless device, and the pertinent information.

### CROSS-REFERENCE TO RELATED APPLICATIONS

This application claims priority to U.S. Provisional Patent Application Ser. No. 62/174,726 filed on Jun. 12, 2015, the disclosure of which is incorporated in its entirety herein by reference and made a part hereof.

### FEDERALLY SPONSORED RESEARCH OR DEVELOPMENT

Not applicable.

### FIELD OF THE INVENTION

The present invention provides a system for electronically detecting the presence of a customer at a sales facility, notifying a salesperson of the presence of the customer at the sales facility, electronically retrieving pertinent information of a customer stored on a server of the sales facility, and displaying the information of the customer to the salesperson and the physical location of the customer within the sales facility.

### BACKGROUND OF THE INVENTION

With the advent of the Affordable Care Act (ACA) and Accountable Care Organizations (ACO) the requirement for Medication Therapy Management (MTM) is more intense. The pharmacist can have a larger purpose in this system. Today, when a patient is ill, she goes to her primary care physician or urgent care. If she is given a prescription, she visits a healthcare retailer to have it filled. The pharmacist reads the prescription and counts the medication—the primary function being a “pill counter.” At this time there is no further consultation provided regarding symptom management—and the patient is left to wander the store to see if there are additional products to help.

The cost for the care and medication is paid for by patient co-pay, private insurance, and a great number through Medicare Part D.

Health care providers and drug retailers are paid on the quantity of care rather than the quality of care (e.g., more, not better). Applicant for the present application believes there is a significant gap around symptom management and Over-the-Counter (OTC) merchandising, one that can be filled by the pharmacist and the healthcare retailer.

Now—with the ACA and ACO in play—the goal is to drive improved health outcomes for the patient. Further, with all payments going through the ACO, the reimbursement levels will be determined by the quality of care. A pay for performance model. This is based on a star rating which is determined by: 1) prescription adherence; 2) reduced hospital re-admittance; and, 3) patient satisfaction. Moreover, with the recent drive to growth in generic prescriptions and lower reimbursement levels underscores the need for the healthcare retailer to provide medication therapy management. It is believed that the pharmacist will be at the core of care having the most interactions with patients, and, therefore, the greatest ability to assist in symptom management. Studies have shown that today ninety-six percent of recommendations made by pharmacists are followed by the patients.

A patient with a pre-diagnosed chronic disease (such as diabetes) or a non-life threatening condition visits a pharmacist at a local healthcare retailer to receive medication therapy management. A basic prescription refill becomes an opportunity to provide suggested OTC products to help manage symptoms and other help. The store is merchandised by disease state categories and solution centers designed around symptoms. Interactivity provides end-to-end product education, ratings, and reviews making it easier for the patient and the pharmacists to navigate the store.

This interactivity will increase prescription adherence, reduce hospital re-admittance, and drive increased patient satisfaction—all keys for improved star ratings, front of store sales, and most important—better health outcomes. Pharmacists that are educated about OTC solutions will come out from behind the pharmacy counter and help patients along their healthcare path.

In short, the platform delivers information to pharmacists in real time for patient consults.

### SUMMARY OF THE INVENTION

The present invention provides a system for merchandising at a sales facility. The system has a first wireless device of an owner/customer, a second wireless device in the sales facility, a low-energy electronic beacon in the sales facility having a transmission range not extending substantially beyond the sales facility, and a software application. When the software application is executed it causes the electronic beacon to transmit a polling beam in the sales facility, senses the presence of the first wireless device in the sales facility, determines the physical location of the first wireless device, searches the database for pertinent information of the owner; and displays on the display the identity of the owner, the physical location of the first wireless device, and the pertinent information.

The system will be described in reference to a pharmacy as the sales facility, and a pharmacist as the salesperson, however, the system could be used in other sales facilities without departing from scope of the present invention.

The present system implement in a pharmacy can improve a patient's/customer's experience while increasing topline sales for the pharmacy. Through the use of technology, this system bridges the gap between pharmacists and patients resulting in: improved health outcomes, improved star ratings, improved basket size, and improved margins.

This system or platform seamlessly delivers information to the pharmacist in real time for patient consults, so that patients can act on front-of-store item recommendations by engaging an i-Beacon, or similarly enabled navigational signage and solution centers, improving the patient's in-store experience.

Other features and advantages of the invention will be apparent from the following specification taken in conjunction with the following Figures.

### BRIEF DESCRIPTION OF THE FIGURES

To understand the present invention, it will now be described by way of example, with reference to the accompanying Figures in which:

FIG. 1 is a flow chart of the present process followed in accordance with the teaching of the present invention.

### DETAILED DESCRIPTION OF THE INVENTION

While this invention is susceptible of embodiments in many different forms, there is shown in the Figures, and will herein be described in detail, preferred embodiments of the invention with the understanding that the present disclosure is to be considered as an exemplification of the principles of the invention, and is not intended to limit the broad aspect of the invention to the embodiments illustrated.

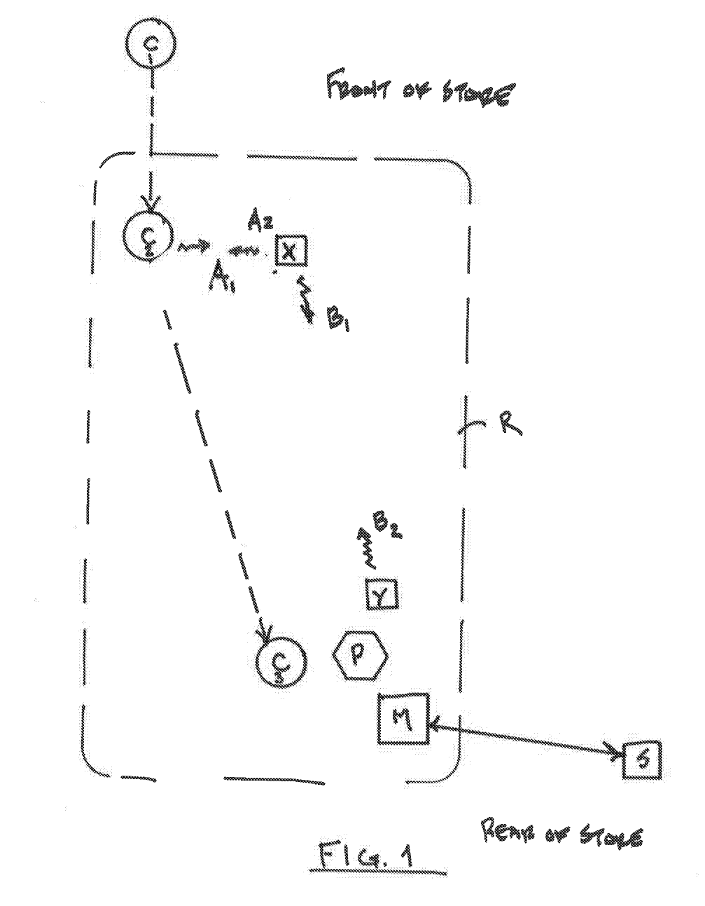

FIG. 1 shows the overall process of a preferred form of the present system.

A patient/potential customer C walks from outside (C-1) a predetermined proximity zone (Range R) into (C-2) the predetermined proximity zone, typically a defined field R, such as the front of a store offering pharmacy services, having a pharmacist P (shown here in the back of the store). By way of example, the customer C has diabetes. The customer C uses his pharmacy's app to help him maintain his prescription records and maintain his health. The customer C goes to the store to pick-up his prescription refills.

Upon the customer C walking within range R (C1 to C2), he is picked-up by a polling beam X. Specifically, before walking into the store (represented by the reference R or Zone 1 with an outside Zone 2), the customer C previously enrolled himself into a loyalty program run by the pharmacy or store and agreed to download an application (app) on her phone. This app is then run in the background on her cell phone. A beam generator X, generating iBeams or low energy Bluetooth beams, constantly polls the store (A2) looking for receivers (cell phones with the store's application on it). The generator's X beam A2 wakes up the customer's C phone and the phone transmits a responsive signal A1 to the polling generator X along with a customer identification code. The beam generator X at the front of the store sends an alert and the customer identification code B1 to a second beam generator Y near the pharmacist P. The pharmacist P receives an alert B2 that a high-value customer C is in her store or department and the customer identification code. The pharmacist P can then identify the customer C in its closed and secure internal database.

In particular, once the alert B1-B2 is received by the pharmacist P, the pharmacist P can call up and open up her computer, tablet or mobile device M, the customer's identification and records via the store's or chain's secure server S and internal network N. Once displayed on her device M, she P can call up condition-specific information she believes might be beneficial to the customer C and discuss the same with the customer C in the pharmacy (C3).

This is particularly useful if the pharmacist P notices that the customer C has not been regularly refilling his medication or in the event the pharmacist P wants to find out if the customer C has had any side effects regarding certain medications. The pharmacist P can then offer particular assistance to the customer C and enhance the customer's experience and perhaps aid in the customer's healthcare.

While one remote beacon generator X is shown at the front of the store, it is recognized that there can be several positioned in different parts of the stores for alerting the pharmacist P. In addition, this system can be used by a customer C to call a pharmacist P. Thus, a customer C standing anywhere in the store can use the application on its phone to call a pharmacist P to answer questions. In such situations, the customer C activates its application or radio button to sends or transmit a signal A1 to a beam generator X with identification information A2. The signal is forwarded from one beam generator X to the pharmacist P (B1-B2) station where the pharmacist P can act thereon, such as by assisting the customer C at a particular location in the store to answer a few questions posed by the customer C.

Many low energy, low cost transmitters/signals “Beams” are available on personal devices (smartphones). These include iBeacon® by Apple for iOS systems, Android, and Google operating systems, and Bluetooth®, BLE, LE and Bluetooth Smart Beacons by Bluetooth SIG, Inc. for other systems, which are all capable of communicating and interacting with other nearby similar systems. This technology enables a smart phone or other device to perform actions when in close proximity to another comparable system. Preferably, the low energy transmitter will have a range of transmission that is substantially within the sales facility.

It is envisioned that the pharmacy will have an application or App the customer C can download onto his smartphone. Such applications or Apps will be made available to customers C through digital libraries (iTunes, Google Play, etc.) and the pharmacy's website (a loyalty program).

It should be emphasized that the pharmacist P stores her necessary records on a secure server S available through a secure network N. Because healthcare and personal records are to be stored and maintained in utmost confidentiality, both of these systems are security intensive. The iBeacon and Bluetooth each are capable of transmitting a universally unique identifier which can be picked-up by a compatible app or operating system. The identifier can then be looked up over the Internet to determine the device's physical location or trigger an action on the device such as a check-in on social media or a push notification.

With respect to the store's application or app, it is recognized that if the terms and conditions of downloading and use are important and depending on what will be done with customer information, such terms and conditions will vary. For example, to the extent the store will be accumulating and using data, it is important that the customer understand and give an informed confirmation and acceptance of the program.

As a result, pharmacists P have huge opportunity to help, engage and influence shoppers where and when it matters most, in the pharmacy (C-3).

In a more general sense, the system and method described above can be used in a variety of sales facilities to assist a salesperson in making sales. The system provides the salesperson an alert that a particular customer is within the sales facility, the location of the customer and pertinent information about the customer. This information will allow the salesperson to find the customer C to assist the customer C in purchasing products and services.

The merchandising system includes a first wireless device of an owner, the device having a first memory, a first processor, and a first low-energy electronic beam transmitter and receiver. The first memory stores a first software application downloaded by the owner of the first wireless device. The first software application download can be part of a registration process where the customer becomes a loyalty member of the sales facility, for example. The system has a second wireless device of the sales facility having a display, a second memory, a second processor, a database storing pertinent information of a plurality of customers including the owner, and the second memory storing a second software product. A low-energy electronic beacon in the sales facility is electronically coupled to the second wireless device and has a transmission range not extending substantially beyond the sales facility and electronically coupling the first wireless device with the second wireless device. The second software application when executed by the second processor takes the following steps: (1) periodically transmit a polling beam in the sales facility with the electronic beacon, (2) senses the presence of the first wireless device in the sales facility when the first wireless device transmits a responsive beam to the second wireless device in response to receiving the polling beam, (3) determines the physical location of the first wireless device; searches the database for pertinent information of the owner; and displays on the display the identity of the owner, the physical location of the first wireless device, and the pertinent information.

While the specific embodiments have been illustrated and described, numerous modifications come to mind without significantly departing from the spirit of the invention and the scope of protection is only limited by the scope of the accompanying Claims.

I claim:

1. A system for merchandising at a sales facility comprising:
a first wireless device of an owner, the device having a first memory, a first processor, and a first low-energy electronic beam transmitter and receiver, the first memory storing a first software application;
a second wireless device having a display, a second memory, a second processor, a database storing pertinent information of a plurality of customers including the owner, and the second memory storing a second software product;
a low-energy electronic beacon in the sales facility having a transmission range not extending substantially beyond the sales facility and electronically coupling the first wireless device with the second wireless device;
the second software application when executed by the second processor takes the following steps:
periodically transmits a polling beam in the sales facility with the electronic beacon;
senses the presence of the first wireless device in the sales facility when the first wireless device transmits a responsive beam to the second wireless device in response to receiving the polling beam;
determines the physical location of the first wireless device;
searches the database for pertinent information of the owner; and
displays on the display the identity of the owner, the physical location of the first wireless device, and the pertinent information.

2. The system of claim 1 wherein the first wireless device is a cellular telephone.

3. The system of claim 1 wherein the low-energy electronic beacon is selected from the group consisting of iBeacon®, Bluetooth®, BLE, LE, and Bluetooth® smart beacons.

4. The system of claim 1 wherein the step of determining the physical location of the first wireless device comprises transmitting with the first wireless device a unique identifier indicative of the physical location of the first wireless device.

5. The system of claim 1 wherein the database is a secure database.
